(19) United States
(12) Patent Application Publication
(10) Pub. No.: US 2015/0344313 A1
(43) Pub. Date: Dec. 3, 2015

(54) METHOD FOR CONTROLLING THE PRODUCTION OF NANOPOWDER OF A GIVEN DIAMETER FROM AT LEAST ACETYLENE CONTAINED IN A PRESSURISED CYLINDER

(71) Applicant: COMMISSARIAT A L'ENERGIE ATOMIQUE ET AUX ENERGIES ALTERNATIVES, Paris (FR)

(72) Inventors: Hicham Maskrot, Montlhery (FR); Benoît Guizard, Saclay (FR); Youssef Atman, Paris (FR)

(73) Assignee: COMMISSARIAT A L'ENERGIE ATOMIQUE ET AUX ENERGIES ALTERNATIVES, Paris (FR)

(21) Appl. No.: 14/654,255

(22) PCT Filed: Dec. 20, 2013
(86) PCT No.: PCT/EP2013/077723

§ 371 Date: Jun. 19, 2015

(30) Foreign Application Priority Data
Dec. 21, 2012 (FR) 1262720

(51) Int. Cl. C01B 31/36; G01N 21/55

(52) U.S. Cl. CPC C01B 31/36; G01N 21/55

(57) ABSTRACT

The invention concerns a method for controlling the production of nanopowder of a given diameter from at least acetylene contained in a pressurised cylinder, comprising defining the colour of the nanopowder and adjusting the rate of discharge from the pressurised cylinder of acetylene on the basis of the colour of the nanopowder. It also concerns a method for producing nanopowder of a given diameter and a given colour from at least acetylene contained in a pressurised cylinder; production being controlled using the abovementioned method.

### TECHNICAL FIELD

The present invention relates to the technical field of the manufacture of technical nanopowder. More particularly, it relates to the technical field of methods for controlling the production of technical nanopowder from acetylene.

### PRIOR ART

During manufacture of technical nanopowder, it is important to control the production parameters to procure nanopowder exhibiting constant physical properties. The constancy of the physical properties of nanopowder is a gauge of its quality. So, it is important to control production of the technical nanopowder.

This control of the production of technical nanopowder can go through taking a sample of technical nanopowder and subjecting this sample to tests and/or measurements.

For example, it is known to control the size of grains of technical nanopowder for example from specific surface measurement and measurement of the density of the nanopowder. These measurements estimate the average elementary size of the grains. Other chemical analyses can be conducted.

However, these measurements and chemical analyses are conducted after production of technical nanopowder. Consequently, the conformity of a batch of technical nanopowder can be confirmed only several days after its production.

Different techniques perform online control, that is, along the production chain, for example spectrometry on plasma induced by laser, more commonly known by the acronym LIBS for “laser-induced breakdown spectroscopy” or multiangle laser light diffusion, more commonly known by the acronym MALLS for “multiangle light scattering”.

LIBS (“laser-induced breakdown spectroscopy”) analysis consists of focusing a pulse laser on the medium and forming plasma from which comes emission spectrometry. This determines the composition of the medium.

MALLS analysis enables measuring the fractal dimension by exploitation of light diffusion techniques applied to fractal measurement. The principle of such a system comprises measuring light diffused by aggregates as per different angles about the analysis tank.

However, these processes fail to determine qualitatively and quantitatively that a single characteristic of the powder at the same time: the chemical composition with the LIBS or the size of grains of nanopowder with the MALLS. The quality of the nanopowder depends on several characteristics such as chemical composition ratios, the size of grains of nanopowder, granulometry and compactness.

A process for controlling nanopowder production taking into account several characteristics of the latter is still necessary to improve the quality of nanopowder produced.

### PRESENTATION

An aim therefore is to eliminate at least one of the disadvantages of the prior art presented hereinabove.

For this, this relates to a method for controlling nanopowder production of given diameter from at least acetylene contained in a pressurised bottle, comprising determining the colour of the nanopowder and adjusting the output rate of the pressurised bottle of acetylene as a function of the colour of the nanopowder.

The originality of the method is that the colorimetry is coupled to regulating the rate of acetylene. In fact, the colour of the nanopowder depends on a set of intrinsic characteristics of nanopowder, such as chemical composition ratios, the size of grains of nanopowder, granulometry and compactness. So, measuring the colour gives access to a sort of synthesis of these characteristics.

Also, the inventors were surprised that the colour of nanopowder produced from acetylene depended also on the rate of this compound at output from the pressurised bottle.

Because of this colorimetric control and regulating of the rate of acetylene, nanopowder exhibiting not only constant physical-chemical properties, properties measured by physical-chemical analyses, for example inductive plasma coupling-atomic emission spectroscopy (ICP-AES for “Inductive Plasma Coupling-Atomic Emission Spectroscopy”), glow discharge spectroscopy (GDS), and mass spectroscopy by glow discharge (GDMS for “Glow Discharge Mass Spectroscopy”), but also constant colour and dissolution in water.

### DIAGRAMS

Other aims, characteristics and advantages will emerge from the following description in reference to the drawings given by way of illustration and non-limiting, in which:

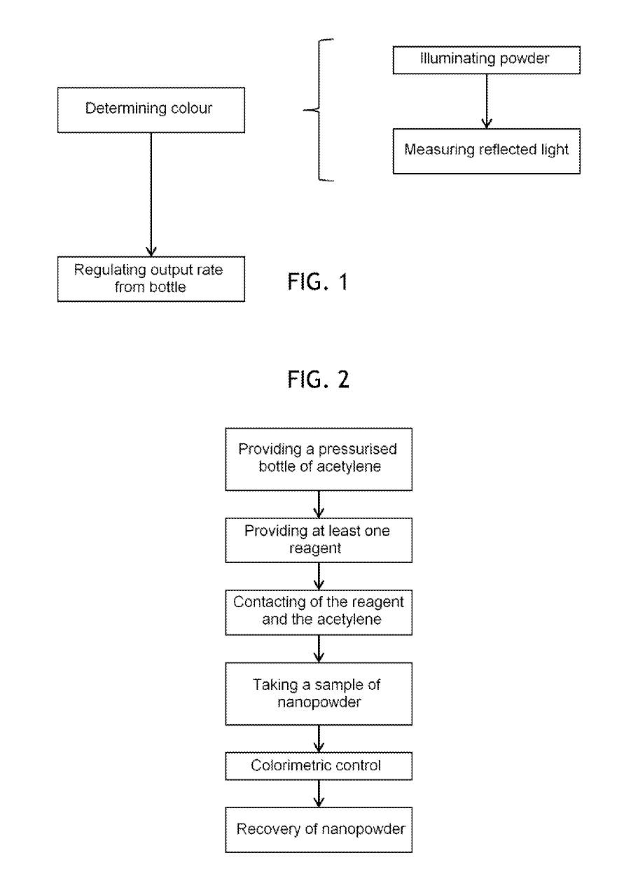

FIG. 1 is a diagram illustrating the different steps of a method for controlling the production of nanopowder;

FIG. 2 is a diagram illustrating the different steps of a method for the manufacture of nanopowder;

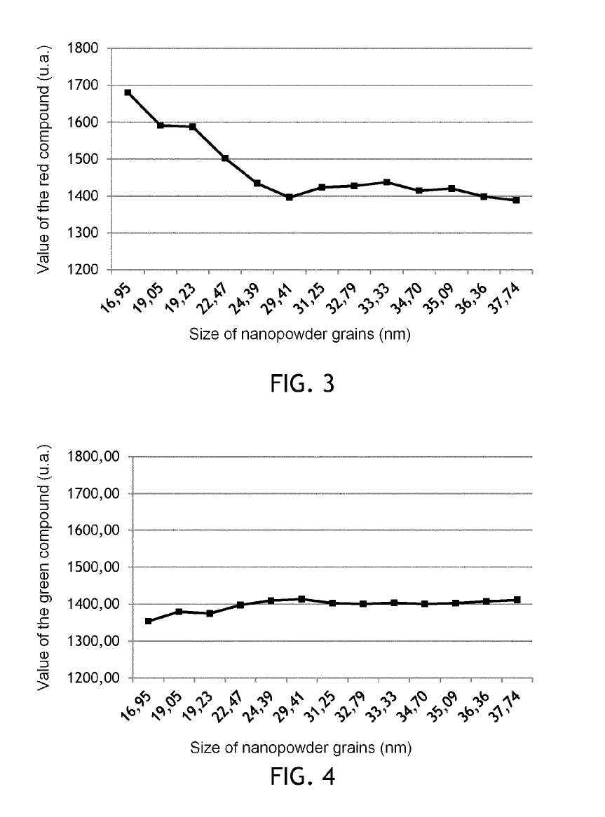

FIG. 3 is a graph showing the intensity of the red compound as a function of the average size of grains of silicon carbide nanopowder; and

FIG. 4 is a graph showing the intensity of the green compound as a function of the average size of grains of silicon carbide nanopowder;

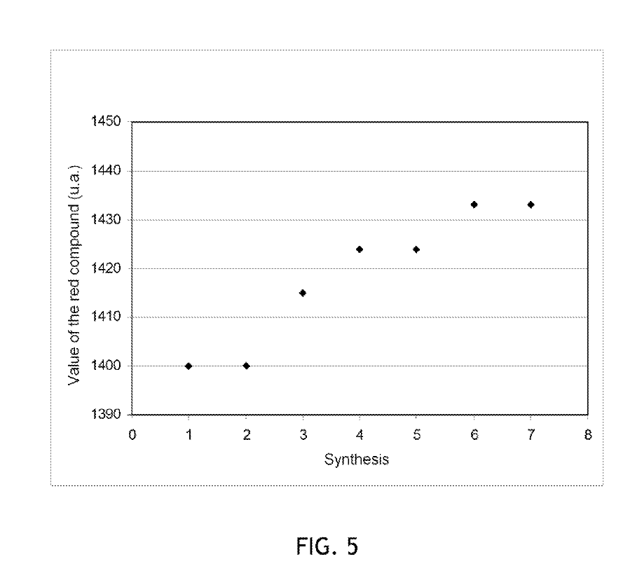

FIG. 5 is a graph showing the variation of the red compound as a function of the synthesis number conducted with the same pressurised bottle of acetylene, with all parameters equal.

### DESCRIPTION

A method for controlling the production of nanopowder of given diameter from at least acetylene contained in a pressurised bottle is described hereinbelow in reference to FIG. 1.

This method comprises determining the colour of the nanopowder and adjusting the output rate of the pressurised bottle of acetylene as a function of the colour of the powder.

Here “nanopowder” means a set of particles or grains whereof the size is of the order of a nanometre, that is, between around 1 nm and around 100 nm. The size of grains is preferably in an interval for which the colour of the nanopowder varies at most from 5%, more preferably 3%, while the size varies at least by over 22%, more preferably by 25%, still preferably by 42%. The variation in size is calculated as follows: if Xₘᵢₙ and Xₘₐₓ are respectively the minimal size and the maximal size of this interval, the variation in size is equal to (Xₘₐₓ−Xₘᵢₙ)/(Xₘₐₓ+Xₘᵢₙ). The variation in colour is calculated as follows: if Rₘᵢₙ and Rₘₐₓ are respectively the minimal value and the maximal value of the colour in this interval, the variation in colour is equal to (Rₘₐₓ−Rₘᵢₙ)/(Rₘₐₓ+Rₘᵢₙ).

For example, for silicon carbide nanopowder these conditions are respected when the size of grains is preferably between around 20 nm and around 50 nm, more preferably between around 24 nm and around 40 nm, still preferably between around 24 nm and around 38 nm (see FIGS. 3 and 4 and table 1 hereinbelow).

TABLE 1

| Average size of | Value of red | Value of green |
|---|---|---|
| grains (nm) | compound (u.a.) | compound (u.a.) |
| 16.95 | 1680 | 1353 |
| 19.05 | 1591 | 1379 |
| 19.23 | 1587 | 1374 |
| 22.47 | 1502 | 1397 |
| 24.39 | 1434 | 1409 |
| 29.41 | 1396 | 1413 |
| 31.25 | 1423 | 1402 |
| 32.79 | 1427 | 1400 |
| 33.33 | 1437 | 1403 |
| 34.70 | 1414 | 1400 |
| 35.09 | 1420 | 1402 |
| 36.36 | 1398 | 1407 |
| 37.74 | 1388 | 1411 |

The method can possibly comprise measuring the size of the diameter of grains of nanopowder. In this way, measuring the size of the diameter of grains of nanopowder would produce a method of stricter control to obtain nanopowder of even greater quality. However, this step is not always necessary as the quality of nanopowder obtained otherwise is already sufficient for application numbers.

The nanopowder is preferably silicon carbide nanopowder. Silicon carbide is generally obtained from acetylene and silane SiH₄ as per the reaction:

2.SiH₄+C₂H₂→2.SiC+5.H₂.

The term “colour” makes reference to electromagnetic waves reflected by the nanopowder. The electromagnetic waves taken into account are those of visible light, that is, those having a wavelength of between around 380 nm and around 750 nm. The term colour designates either the electromagnetic waves at a given wavelength or at a given interval of wavelengths. The term “colour” also refers to light decomposition processes for digital processing of the latter, that is, RGB processes (“red-green-blue” also called additive system), CMY (“cyan-magenta-yellow” also called subtractive system, also known under the acronym YMC for “yellow-magenta-cyan”) or again HSL (“hue-saturation-lightness”). The term “colour” designate one of the light compounds or any combination of the latter in the planned decomposition process.

The decomposition process is preferably the RGB process. In this process, reflected light is captured and decomposed into three compounds: (red, green, blue). These three colours more or less correspond to the three wavelengths to which the three types of cones of the human eye are sensitive. Addition of the three gives the white of the human eye. In this way, each visible colour receives a set of coordinates. However, not all visible colours can be rendered in RGB and particular decompositions have been worked out to make managing colour in a computer system easier. All the same, no matter the RGB decomposition used, the principle is identical.

More preferably, only those colours from red, green and blue mainly forming the composition of the colour of the nanopowder are used. For example, for silicon carbide nanopowder SiC, only the red and the green can be included as the colour of silicon carbide varies from white to yellow (mixture of red and green in the additive system). Always preferably, only red is included for SiC. In fact, red is the compound which presents the widest variation throughout non-controlled production of nanopowder.

The term “output rate” means rate adjusted at output from the pressurised bottle, that is, that of the pressure regulator between the pressurised bottle and a tube or conduit for conveying acetylene to a reactor where formation of the nanopowder takes place.

Acetylene, of chemical formula HC≡CH, is a gas at ambient temperature kept in pressurised bottles. In fact, acetylene is rarely kept only in these pressurised bottles, as it is mixed with acetone. As it leaves the bottle, the gas contains 0.1 to 2.5% acetone, or 97.5 to 99.9% acetylene.

During use of the bottle of acetylene, at a given output rate, the quantity of acetylene sent to the reactor is therefore not constant over time. In fact, the acetylene/acetone ratio inside the pressurised bottle drops with consumption of the latter such that at start of use, the quantity of acetylene is greater than that at end of use.

For example, FIG. 5 and table 2 below show that for different syntheses of silicon carbide nanopowder from silane and acetylene, whereof the acetylene comes from a single pressurised bottle, the colour of the nanopowder varies in spite of the same parameters also fixed such that the output rate of the bottle, reagents, laser power, pressure, duration of synthesis, etc. More particularly, in table 2, the syntheses are successive, the time indicates time of syntheses cumulated.

TABLE 2

| | Time | Compound X |
|---|---|---|
| Synthesis No. | (min) | (u.a) |
| 1 | 120 | 1400 |
| 2 | 170 | 1425 |
| 3 | 290 | 1424 |
| 4 | 410 | 1433 |
| 5 | 515 | 1501 |

Determining the colour can be done by illuminating the powder with a light source followed by measuring the light reflected by the powder.

Measuring the light reflected by the powder can consist of a sensor capturing the intensity of the light reflected at wavelengths corresponding to the visible field, preferably the red colour (that is, between around 630 nm and around 780 nm) and green (that is, between around 492 nm and around 575 nm), more preferably the colour red.

When the decomposition process used is RGB, the three colours can be captured and only the red and possibly the green are used.

The rate of acetylene can be regulated by means of a chart matching the colour of the powder with an output rate increase value of the pressurised bottle of acetylene. A production method of nanopowder of given diameter and given colour from at least acetylene contained in a pressurised bottle is described hereinbelow in reference to FIG. 2.

This method comprises the following steps:
providing a pressurised bottle of acetylene;
providing at least one reagent capable of reacting with the acetylene to produce the nanopowder;
contacting of the reagent with the acetylene to form nanopowder;
taking a sample of nanopowder;
colorimetric control of the sample of nanopowder by means of the method described hereinabove; and
recovery of the nanopowder.

1. A method for controlling the production of nanopowder of given diameter from at least acetylene contained in a pressurised bottle, comprising determining the colour of the nanopowder and adjusting the output rate of the pressurised bottle of acetylene as a function of the colour of the nanopowder.

2. The method according to claim 1, wherein the nanopowder produced is silicon carbide nanopowder.

3. The method according to claim 1 or claim 2, wherein determining the colour is carried out by:
illumination of the nanopowder with a light source; and
measuring the light reflected by the nanopowder.

4. The method according to claim 3, wherein measuring the light reflected by the nanopowder comprises capturing the intensity of the light reflected at wavelengths corresponding to the colour red.

5. The method according to claim 4, wherein the wavelengths corresponding to the colour red are at an interval of 630 nm to 780 nm.

6. The method according to claim 1, wherein a matching chart between the colour of the nanopowder and the rate of acetylene is used to adjust the rate of acetylene.

7. The method according to claim 1, further comprising measuring the size of the diameter of the grains of nanopowder.

8. A production method for nanopowder of given diameter and given a colour from at least acetylene contained in a pressurised bottle, comprising:
providing a pressurised bottle of acetylene;
providing at least one reagent capable of reacting with acetylene to produce nanopowder;
contacting of the reagent with the acetylene to form nanopowder;
taking a sample of nanopowder;
colorimetric control of the sample of nanopowder by means of the method according to claim 1; and
recovery of the nanopowder.
